(19) United States
(12) Patent Application Publication
(10) Pub. No.: US 2012/0037666 A1
(43) Pub. Date: Feb. 16, 2012

(54) Anti-Drip Valve for Fluid Dispensers

(75) Inventor: William A. Miller, Buffalo Grove, IL (US)

(73) Assignee: Fluid Management Operations, LLC, Wheeling, IL (US)

(21) Appl. No.: 12/855,007

(22) Filed: Aug. 12, 2010

(51) Int. Cl. B67D 7/70; F01L 3/10; B23P 11/00; B67D 7/58

(52) U.S. Cl. 222/255; 251/337; 29/428; 222/380

(57) ABSTRACT

An anti-drip valve assembly for a fluid dispenser is disclosed that includes a valve block and a cylindrical valve body disposed within the valve block. The cylindrical valve body includes a recess for accommodating a valve element. The recess is in communication with the chamber for accommodating a biasing element for biasing the valve element outward and away from the valve body or towards the valve block or dispense port, depending upon the position of the valve body. When the valve body is in a closed position, the valve element is biased against the dispense port. When the valve body is in a dispense position, and there may be a plurality of dispense positions, the dispense port is selectively in communication with a fluid passageway or one of a plurality of fluid passageways for dispensing fluid through the dispense port. The valve assembly is particularly useful for fluid dispensers employing more than one pump for dispensing a common fluid in different amounts.

### TECHNICAL FIELD

This disclosure relates generally to fluid dispensers. More specifically, this disclosure relates to mechanisms for preventing or limiting post-dispense dripping of fluids dispensed from such fluid dispensers.

### DESCRIPTION OF THE RELATED ART

Systems for dispensing a plurality of different fluids into a container have been known and used for many years. For example, systems for dispensing paint base materials and colorants into a paint container are known. These paint systems may use twenty or more different colorants to formulate a paint mixture. Each colorant is contained in a separate canister or package and may include its own dispensing pump. The colorants and the respective pumps may be disposed on a turntable or along one or more horizontal rows. In a turntable system, the turntable is rotated so that the colorant to be dispensed is moved to a position above the container being filled. In designs using one or more horizontal rows, the container may be moved laterally to the appropriate colorant/pump.

Systems for dispensing large varieties of different fluids are not limited to paints, but also include systems for dispensing pharmaceutical products, hair dye formulas, cosmetics of all kinds, nail polish, beverages, flowable food items, etc.

In many fluid dispensing applications, precision is essential as many formulations require the addition of precise amounts of certain ingredients. This is true in the pharmaceutical industry but also in the paint and cosmetic industries as the addition of more or less tints or colorants can result in a visible change in the color of the resulting product.

One way in which the precision of dispensing systems is compromised is “dripping.” Specifically, a “leftover” drip may be hanging from a nozzle that was intended to be added to a previous formulation and, with a new container in place under the nozzle, the drop of liquid intended for a previous formulation may be erroneously added to a new formulation. Thus, the previous container may not receive the desired amount of the liquid ingredient and the next container may receive too much.

To solve the drip problem, various scraper and wiper designs have been proposed. However, these designs often require one or more different motors to operate the wiper element and are limited to use on dispensing systems where the nozzles are separated or not bundled together in a manifold.

Another problem associated with dispensing systems that make use of nozzles lies in the dispensing of relatively viscous liquids such as tints, colorants, base materials for cosmetic products, certain pharmaceutical ingredients or other fluid materials having relatively high viscosities. Specifically, the viscous fluids have a tendency to dry and cake onto the end of the nozzles, thereby requiring frequent cleaning in order for the nozzles to operate effectively. While some mechanical wiping or scrapping devices are available, these devices are not practical for multiple nozzle manifold systems and the scraper or wiper element must be manually cleaned anyway. Further, using a scraper or wiper on a multiple nozzle manifold system creates cross-contamination of materials at the various nozzles.

Finally, in terms of paints and other solvent-base materials, there is an increasing trend in regulations at both the state and federal levels limiting the use of volatile organic compounds (VOCs). Low-VOC or no-VOC colorants for paints as well as other low- or no-VOC liquids or slurries may have lower viscosities thereby contributing to the dripping problem described above.

### SUMMARY OF THE DISCLOSURE

An anti-drip valve assembly for a fluid dispenser is disclosed. The disclosed anti-drip valve assembly comprises of a valve block and a cylindrical valve body disposed within the valve block. The cylindrical valve body comprises a recess accommodating a valve element. The recess is in communication with a chamber for accommodating a biasing element for biasing the valve element outward away from the valve body. The recess is in alignment with a dispense port disposed in the valve block. The dispense port is selectively in communication with at least one fluid passageway when the valve body is in a dispense position and the valve element is biased against the dispense port when the valve body is in a closed position.

In a refinement, the valve body is moveable between the closed position and at least two dispense positions. In a first dispense position, the dispense port is in communication with a first fluid passageway. In a second dispense position, the dispense port is in communication with a second fluid passageway.

In a refinement, the valve element is biased against a portion of the valve block that is not in alignment with the dispense port when the valve body is in either the first or second dispense positions.

In a refinement, the valve body is connected to a handle. The handle may be used for selectively moving the valve body between the closed, first dispense position and second dispense position.

In a refinement, the valve element is a poppet valve.

In a refinement, the biasing element is a spring for biasing the valve element against the dispense port or valve block.

An improved fluid dispenser is also disclosed which comprises a canister of fluid that is coupled to at least two pumps including a first pump and a second pump. Communication between the canister and the pumps is established through a valve block. The valve block accommodates a cylindrical valve body. The cylindrical valve body comprises a recess for accommodating a valve element. The recess is in communication with a chamber for accommodating a biasing element for biasing the valve element outward away from the valve body. The recess is in alignment with a dispense port disposed in the valve block when the fluid dispenser is in a closed position. The dispense port is selectively in communication with a first fluid passageway that is in communication with the first pump when the valve body is in a first dispense position. The dispense port is selectively in communication with a second fluid passageway that is in communication with the second pump when the valve body is in a second dispense position.

In a refinement, the valve element is biased against a portion of the valve block that is not in alignment with the dispense port when the valve body is in either the first or second dispense positions.

A method for retrofitting a fluid dispenser with an anti-drip valve is also disclosed. The method comprises providing a fluid dispenser that comprises a canister of fluid coupled to at least two pumps including the first pump and the second pump and wherein the communication is established through a valve block. The valve block accommodates the cylindrical valve body. A dispense port in the valve block is selectively in communication with a first fluid passageway that is in communication with the first pump when the valve body is in a first dispense position. The dispense port is in communication with a second fluid passageway that is in communication with the second pump when the valve body is in a second dispense position. The method comprises replacing the cylindrical valve body described above with a new cylindrical valve body comprising a recess for accommodating a valve element. The recess is in communication with a chamber for accommodating a biasing element for biasing the valve element outward away from the new cylindrical valve body. The recess is in alignment with the dispense port disposed in the valve block when the new cylindrical valve body is in the closed position.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail in the accompanying drawings, wherein:

FIG. 1 is a partial perspective view of a fluid dispenser illustrating a single canister, two pumps, a valve and a product receptacle;

FIG. 2 is a bottom perspective view of the dispenser illustrated in FIG. 1, particularly illustrating the valve in an open position with respect to the large pump and a closed position with respect to the small pump;

FIG. 3 is another bottom perspective view of the dispenser illustrated in FIGS. 1-3, particularly illustrating the valve body in a closed position with respect to both pumps;

FIG. 4 is an exploded view of an improved valve body made in accordance with this disclosure;

FIG. 5 is an exploded view of the valve body illustrated in FIG. 4 and the valve block illustrated in FIGS. 1-3;

FIG. 6 is another perspective view of the improved valve body disclosed herein; and

FIG. 7 is another perspective view of the improved valve body disclosed herein.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE PRESENTLY PREFERRED EMBODIMENTS

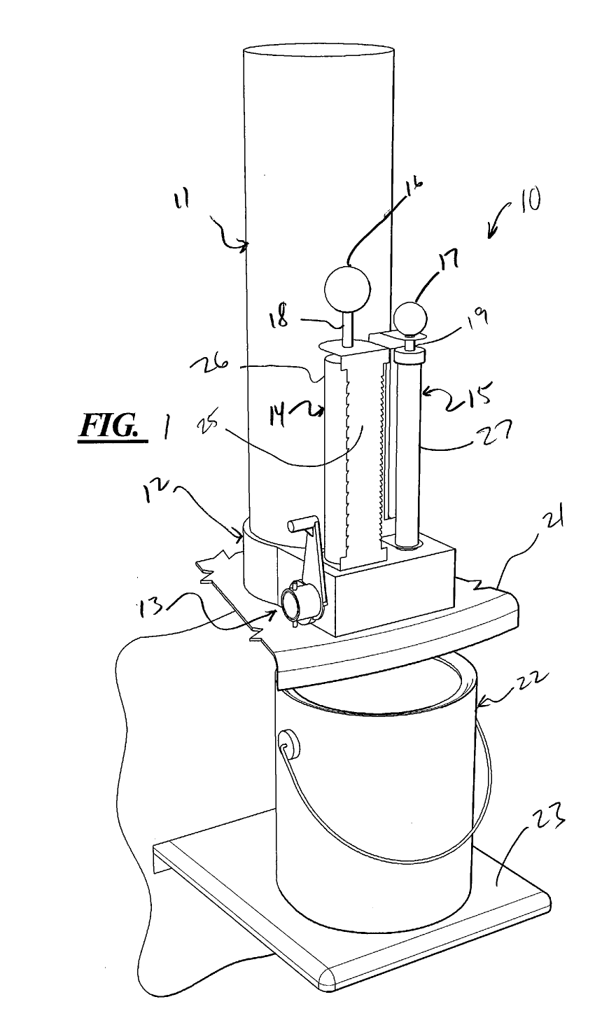

Turning to FIG. 1, a partial view of a dispenser 10 is disclosed which includes a canister 11 disposed on a valve block 12 that accommodates a valve assembly 13. The dispenser 10 includes two pumps, including a larger pump 14 and a smaller pump 15. Each pump 14, 15 includes a knob or handle 16, 17 connected to a piston stem 18, 19. Only one canister/pump 14/pump15/valve block 12/valve assembly 13 is illustrated in FIG. 1. A plurality of such combinations may be typically mounted on the turntable 21, which may be operated manually or by a suitable motor (not shown). A linear arrangement is also possible. A dispense canister is shown at 22 disposed on a platform 23. Pump 14 also includes a scale or gage 25 and a similar scale or gage may be employed for the small pump 15. In one embodiment, the pump 14 is a five fluid ounce pump which is capable of dispensing from less than five fluid ounces in a single stroke of the piston 18 when the pump cylinder 26 is full. The pump 15, on the other hand, may be a one fluid ounce pump and intended to dispense materials in one fluid ounce increments only (assuming the pump cylinder 27 is full) or in amounts less than one fluid own and therefore a scale or gage for the pump 15 may or may not be necessary for the pump 15.

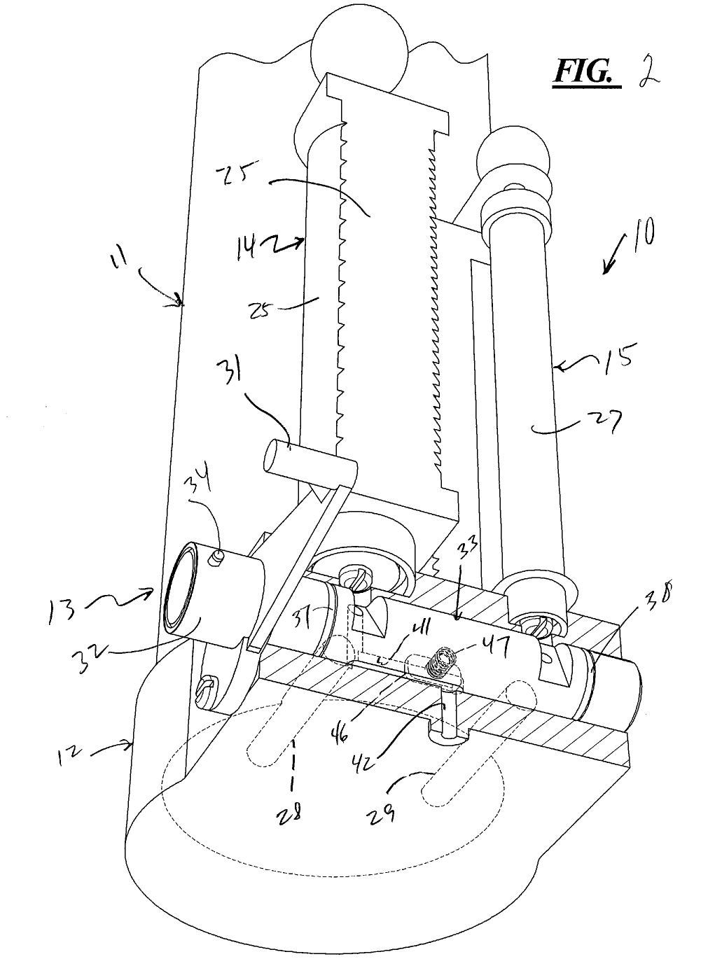

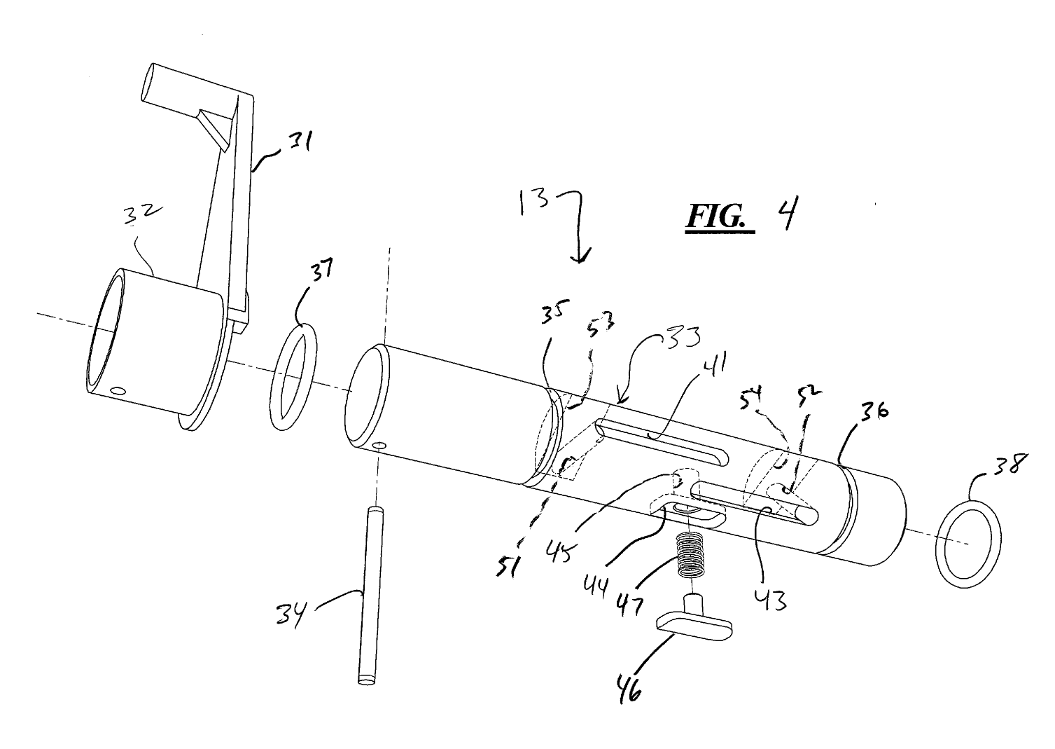

Turning to FIG. 2, the valve block 12 is in communication with the canister 11 via the passageways 28, 29, shown in phantom. The passageways 28, 29 connect the canister 11 to the valve assembly 13. Referring to FIGS. 2 and 4, the valve assembly 13 includes a handle 31 coupled to a collar 32. The collar 32 is connected to the valve body 33 by the pin 34. The valve body 33 includes peripheral grooves 35, 36 for accommodating the seal elements 37, 38. The first passageway 41 provides communication between the passageway 28 and the dispense port 42 as illustrated in FIG. 2. In FIG. 2, the handle 31 has been rotated so the dispenser 10 is open with respect to the large pump 14. Specifically, fluid passes through the passageway 28, through the first passageway 41 and down through the dispense port 42. As also seen in FIG. 2, the small pump 15 is isolated as no communication exists between the passageway 29 and the dispense port 42 in the position illustrated in FIG. 2.

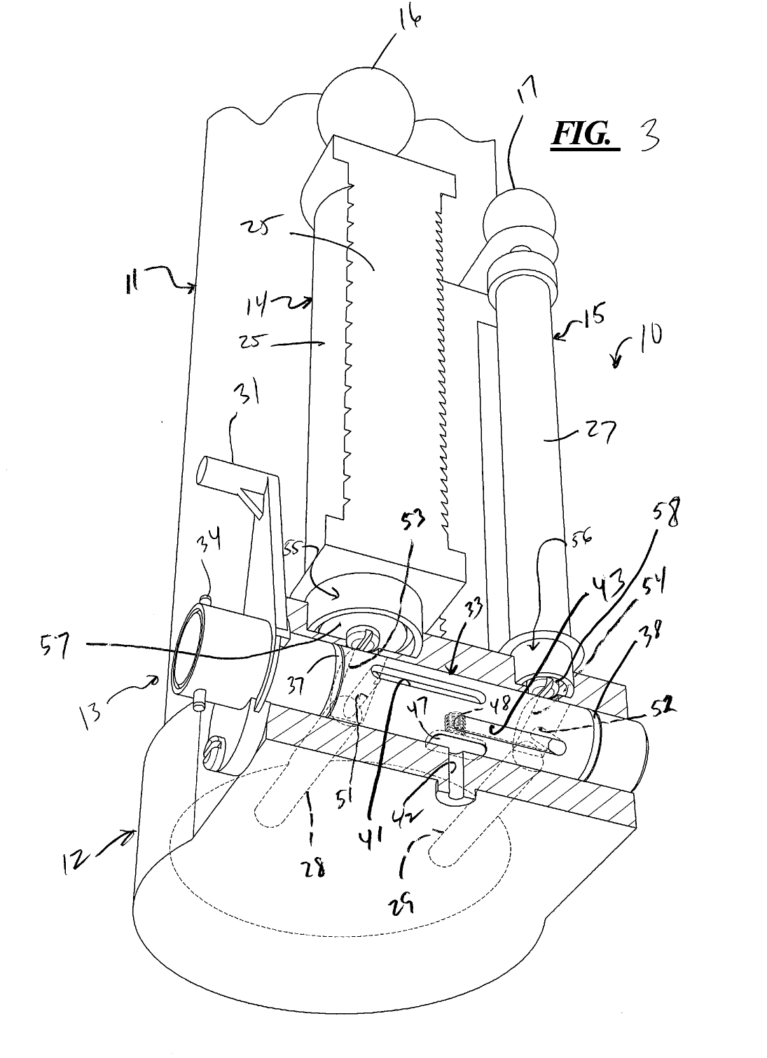

Returning to FIG. 4, the valve body 33 also includes a second fluid passageway 43 which provides communication between the passageway 29 and the dispense port 42 when the handle 31 has been rotated to a position for dispensing from the small pump 15. Such a position is not illustrated in the figures as shown but it will be apparent to one skilled in the art that such a position exists between the closed position illustrated in FIG. 3 and the open position for the large pump 14 illustrated in FIG. 2. Referring to FIG. 4, the valve body 33 includes a recess 44 and an additional chamber 45. The recess 44 accommodates the valve element 46 and the chamber 45 accommodates the biasing element 47.

Turning to FIG. 3, the handle 31 has been rotated so that both sets of passageways 28, 41 and 29, 43 are isolated from the dispense port 42. Thus, FIG. 3 illustrates the dispenser 10 in the closed position.

Referring to FIGS. 3 and 4, the means for priming or loading the pumps 14, 15 will now be described. FIGS. 3 and 4 illustrate passageways 51, 52 that are connected to transverse slots 53, 54. When the handle 31 is in the closed position as illustrated in FIG. 3, the passageways 28, 29 that are in communication with the canister 11 are also in communication with the slots 53, 54 which, in turn, are coupled to the bottoms 55, 56 of the pumps 14, 15 which include the piston heads 57, 58 which draw fluid into the pump canisters 25, 27. Therefore in the closed position in FIG. 3, raising either knob 16, 17 draws the piston stems 18, 19 and piston heads 57, 58 upward to draw fluid through the passageways 28, 29 and through the transverse slots 53, 54 and into the pump canisters 25, 27, resulting in the priming of the pumps. Fluid may also pass through the passageways 41, 43 so that no air bubbles are dispensed through the dispense port 42 when a dispense is carried out as illustrated in FIG. 2.

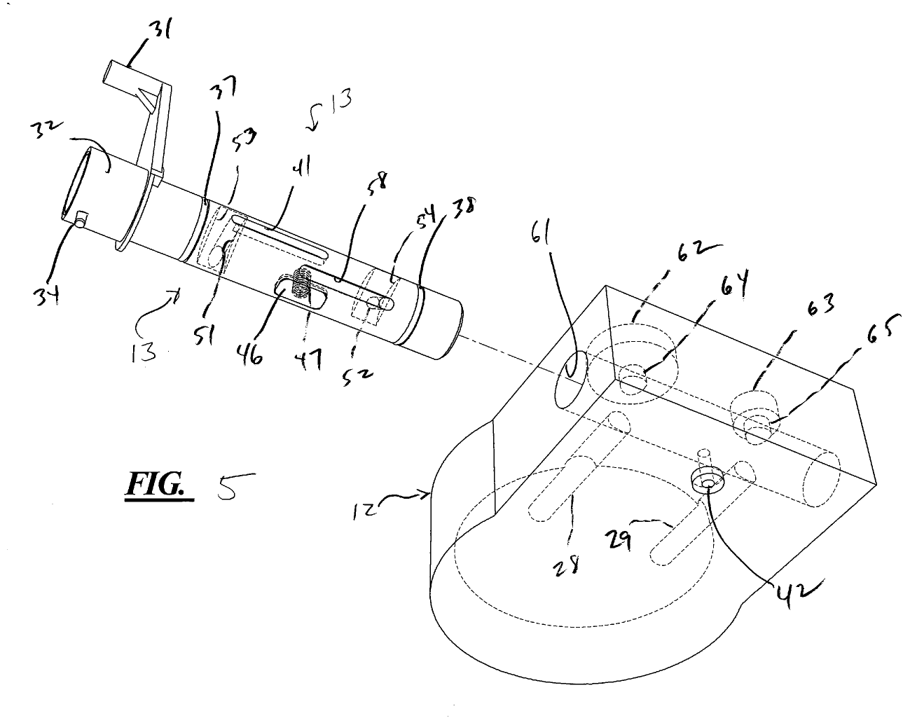

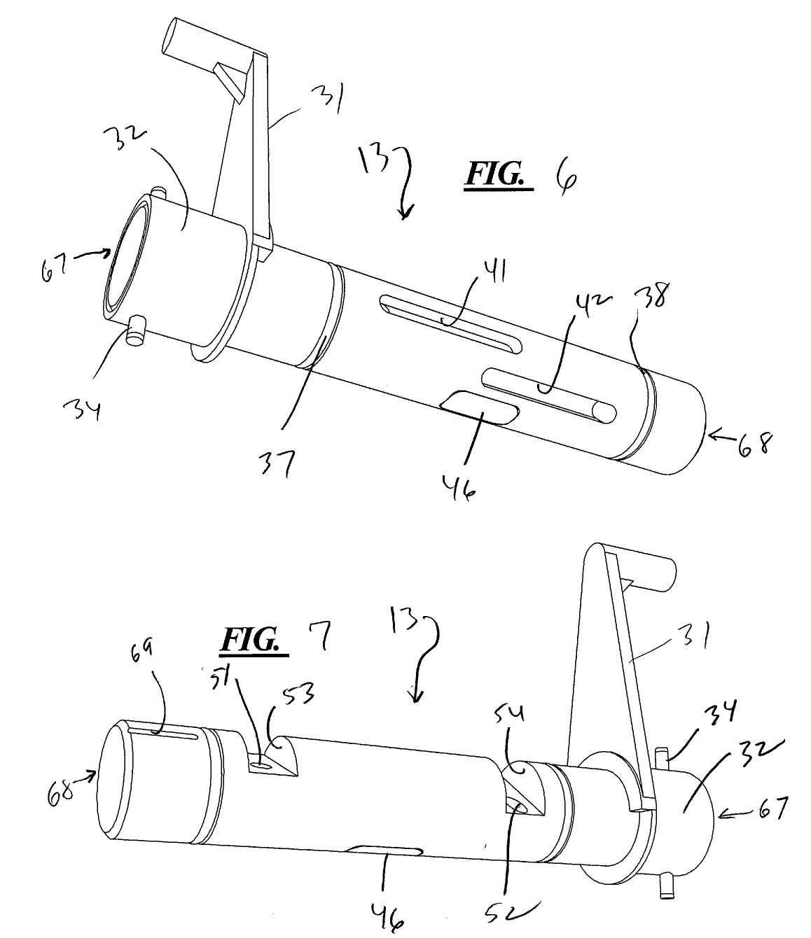

FIG. 5 illustrates the insertion of the valve assembly 13 through the cylindrical opening 61 of the valve block 12. The valve block 12 also includes recesses 62, 63 that are in alignment with the piston heads 57, 58. The shorter passageways 64, 65 channel the flow in a more direct fashion to the transverse passageways 41, 58 during dispensing from the pumps 14, 15 respectively. FIGS. 6 and 7 provide additional views of the valve assembly 13.

It will be noted that valve assembly 13 include proximal and distal ends 67, 68 respectively and the distal end 68 includes a key slot 69 to facilitate assembly of the valve assembly 13 into the valve block 12.

While only certain embodiments have been set forth, alternatives and modifications will be apparent from the above description to those skilled in the art. These and other alternatives are considered equivalents and within the spirit and scope of this disclosure and the appended claims.

Thus, an improved valve assembly and an improved semi-manual fluid dispenser are disclosed that eliminate or at least alleviate the dripping problem associated with dispensing low viscosity fluids.

What is claimed is:

1. An anti-drip valve assembly for fluid dispenser comprising:
a valve block;
a cylindrical valve body disposed within the valve block;
the cylindrical valve body comprising a recess for accommodating a valve element;
the recess in communication with a chamber for accommodating a biasing element for biasing the valve element outward away from the valve body;
the recess being in alignment with a dispense port when the valve body is in a closed position;
the dispense port being selectively in communication with at least one fluid passageway when the valve body is in the dispense position;
the valve element being biased against the dispense port when the valve body is in the closed position.

2. The valve assembly of claim 1 wherein the valve body is movable between the closed position and two dispense positions;
in a first dispense position, the dispense port is in communication with a first fluid passageway;
in a second dispense position, the dispense port is in communication with a second fluid passageway.

3. The valve assembly of claim 2 wherein the valve element is biased against a portion of the valve block that is not in alignment with the dispense port when the valve body is in either the first or second dispense positions.

4. The valve assembly of claim 1 wherein the valve body is connected to a handle.

5. The valve assembly of claim 1 wherein the valve body is connected to a handle for selectively moving the valve body between the closed, first dispense position and second dispense position.

6. The valve assembly of claim 1 wherein the valve element is a poppet valve.

7. The valve assembly of claim 1 wherein the biasing element is a spring for biasing the valve element against the dispense port or valve block.

8. A fluid dispenser comprising:
a canister of fluid, the canister of fluid coupled to at least two pumps through a valve block, then at least two pumps including a first pump and a second pump;
the valve block accommodating a cylindrical valve body;
the cylindrical valve body comprising a recess for accommodating a valve element;
the recess in communication with a chamber for accommodating a biasing element for biasing the valve element outward away from the valve body;
the recess being in alignment with a dispense port disposed in the valve block when the fluid dispenser is in a closed position;
the dispense port being selectively in communication with a first fluid passageway that is in communication with the first pump when the valve body is in a first dispense position;
the dispense port being selectively in communication with a second fluid passageway that is in communication with the second pump when the valve body is in a second dispense position.

9. The fluid dispenser of claim 8 wherein the valve element is biased against a portion of the valve block that is not in alignment with the dispense port when the valve body is in either the first or second dispense positions.

10. The fluid dispenser of claim 8 wherein the valve body is connected to a handle.

11. The fluid dispenser of claim 8 wherein the valve body is connected to a handle for selectively moving the valve body between the closed, first dispense position and second dispense position.

12. The fluid dispenser of claim 8 wherein the valve element is a poppet valve.

13. The fluid dispenser of claim 8 wherein the biasing element is a spring for biasing the valve element against the dispense port or valve block.

14. A method for retrofitting a fluid dispenser with an anti-drip valve, the method comprising:
providing a fluid dispenser comprising a canister of fluid, the canister of fluid coupled to at least two pumps including a first pump and a second pump through a valve block, the valve block accommodating a cylindrical valve body, a dispense port in the valve block being selectively in communication with a first fluid passageway that is in communication with the first pump when the valve body is in a first dispense position, the dispense port is in communication with a second fluid passageway that is in communication with the second pump when the valve body is in a second dispense position;
replacing the cylindrical valve body with a new cylindrical valve body comprising a recess for accommodating a valve element, the recess in communication with a chamber for accommodating a biasing element for biasing the valve element outward away from the new cylindrical valve body, the recess being in alignment with the dispense port disposed in the valve block when the new cylindrical valve body is in the closed position.

15. The method of claim 14 wherein the valve element is biased against a portion of the valve block that is not in alignment with the dispense port when the valve body is in either the first or second dispense positions.

16. The method of claim 14 wherein the new cylindrical valve body is connected to a handle.

17. The method of claim 14 wherein the valve body is connected to a handle for selectively moving the valve body between the closed, first dispense position and second dispense position.

18. The method of claim 14 wherein the valve element is a poppet valve.

19. The method of claim 14 wherein the biasing element is a spring for biasing the valve element against the dispense port or valve block.
